(19) United States
(12) Patent Application Publication
(10) Pub. No.: US 2011/0126647 A1
(43) Pub. Date: Jun. 2, 2011

(54) RATE OF TURN SIGNAL GENERATOR WITH DRIFT COMPENSATION

(76) Inventor: Dave Newland, Abbotsford (CA)

(21) Appl. No.: 12/949,202

(22) Filed: Nov. 18, 2010

Related U.S. Application Data
(60) Provisional application No. 61/265,415, filed on Dec. 1, 2009.

(51) Int. Cl. G01C 19/42

(52) U.S. Cl. 74/5.6 R

(57) ABSTRACT

Apparatus for generating a rate of turn signal includes a gyroscopic device arranged to generate the output indicative of the rate of turn in a desire plane relative to a nominal predetermined direction. The rate of turn signal includes a drift error generated by a drift of the actual predetermined direction and the error is corrected by generating a first signal with the gyroscopic device in a first orientation and a second signal with the gyroscopic device in a second orientation inverted relative to the first orientation so that the readings will now be in the opposite direction, comparing the two signals to determine the drift error and using the drift error to correct the output.

This application claims priority under 35 U.S.C. 119 from Provisional Application Ser. No. 61/265,415 filed Dec. 1, 2009.

This invention relates to rate of turn signal generator for use in ship navigation and particularly by a ship's pilot where the output signal is corrected for drift compensation without reference to an exterior input source.

### BACKGROUND OF THE INVENTION

A number of developments have recently been undertaken to create a signal generator based on a gyroscopic signal which calculates and outputs a signal indicative or proportional to a rate of turn of the ship.

Attempts are made to provide a signal having an accuracy of the order of 0.1 degrees per minute.

Devices of this type use an electronic gyroscopic component as the source so that the output of the component is a voltage which is proportional to the rate of turn of the gyroscope in the selected plane. This output can be provided as a raw signal for input into navigation software separate from the device itself. Alternatively the device can itself use internal software to manipulate the raw signal into a digital output indicative of the rate of turn or other software can be used to provide other navigational signals to be used by the ship's systems or in a portable unit carried by a pilot onto the ship.

Many gyroscopic devices of this type are available, none of which use a conventional rotating gyroscope but instead use various electronic components which can be cheaply and accurately manufactured for the required characteristics.

Examples are:

A piezoelectric gyroscope where a piezoelectric material can be induced to vibrate, and lateral motion due to coriolis force can be measured to produce a signal related to the rate of rotation.

Wine glass resonator, also called the hemispherical resonator gyro, or the HRG. Hemisphere driven to resonance and nodal points measured to indicate rotation.

Tuning fork gyroscope where a pair of test masses are driven to resonate and their displacement from the plane of oscillation is measured to produce a signal related to the rate of rotation.

Vibrating wheel gyroscope where a wheel is driven to rotate a fraction of a full turn about its axis. Tilt of the wheel is measured to produce a signal related to the rate of rotation.

MEMS gyroscope which is a relatively inexpensive vibrating structure gyroscopes using MEMS technology. These can be implemented as the tuning fork resonator, vibrating wheel or (planar) wine glass resonator.

A rate gyro or rate of turn generator is not normally considered to be a long term reference source. Over a period of time the output will drift as there is no reference to any fixed point in space. A rate of turn output error from a MEMS sensor will shift slowly within a given known range and is not cumulative. It is desirable to remove this error periodically. This can be done by monitoring a heading source. A heading can be derived from the rate gyro by integrating the output over time. The heading derived in this way will accumulate uncertainty over time.

Suitable arrangements which provide a sensitive, portable rate of turn generator for use by ships pilots are available. Such a unit is intended to be used as part of a portable navigation system. The components are standard parts including the MEMS gyro sensor which is selected according to required suitable characteristics. There are many sensors on the market.

The primary use of the device is to provide a rate of turn at 0.1 degrees per min or better accuracy over a span of plus 50 to minus 50 degrees per min.

The secondary purpose is to provide a heading reference for some period of time when the ships instruments are not available due to system failure or incompatibility with the pilots portable system. The length of time for this heading to remain usable is governed by the drift error. Other uses for the unit are related to permanent installation as an inexpensive alternative to a laser gyro. The laser gyro is the most accurate available and can be more accurate than units using the MEMS gyro.

Electronic gyro navigation systems inherently drift over time in a small but unpredictable manner. The typical way of compensating for this is to periodically make corrections based on alternative references such as a compass, visual, or GPS reading. For instance a rate gyro would be manually zeroed by the user or a system while it is known that the system or vehicle is at rest or not turning. After this the readings will be valid for a period of time depending on the drift rate and the accuracy needed by the user.

In some situations the system has access to an outside reference (for example from the ships instruments) for the purpose of removing the drift error. However this cannot be relied upon and is sometimes not available due to failure or incompatibility.

### SUMMARY OF THE INVENTION

According to one aspect of the invention there is provided an apparatus for generating a rate of turn comprising:

a gyroscopic device arranged to generate an output indicative of a rate of turn in a desire plane relative to a nominal predetermined direction, the rate of turn signal including a drift error;

and an arrangement for removing the drift error;

the arrangement being arranged:

to generate a first signal with the gyroscopic device in a first orientation;

to generate a second signal with the gyroscopic device in a second orientation inverted relative to the first orientation so that the readings will now be in the opposite direction;

to compare the two signals to determine the drift error;

and using the drift error to correct the output.

Preferably the arrangement obtains the drift error without reference to another device.

Preferably the arrangement obtains the drift error without manual intervention.

Preferably the gyroscopic device is located in a portable unit and the whole unit is inverted.

Preferably the gyroscopic device is inverted relative to a housing within which the device is located.

Preferably the gyroscopic device is inverted by a motor within the housing.

Preferably the arrangement acts to take the difference between the two readings.

Preferably a heading is derived from the rate gyro by integrating the output over time.

The device that is being studied is primarily designed for navigation of large ships but can be applied to a wide range of vehicles. This drift correction technique is to be applied to any suitable rate sensor. The drift corrected rate instrument can then be used for any type of vehicle (manned or not) in any environment.

The device can be used on a ship or in other marine situations such as submarines or other manned and unmanned vehicles.

The arrangement herein provides a new method of removing the drift error from an electronic gyro based navigation system.

The new method does not need to refer to another device or manual intervention to periodically correct the drift error. The rate gyro is used to sense the rate of turn in a desired plane.

The rate gyro unit is then inverted in the same plane, that is rotated by 180 degrees so that it is still sensing in the same plane but the readings will now be in the opposite direction.

The system will then take the difference between the two rates caused by the drift error and can then be used to correct the output.

Thus, in a turn of 10 degrees per minute and the gyro is sensing +10 deg per minute, then the gyro is flipped over it will sense −10 deg per min, in the absence of drift, that is at a drift angle of zero. The system can be programmed to use the output either way as long as the orientation (inverted or not inverted) is known.

For example with a drift angle of 1 degree per minute, if the gyro is reporting +11 deg per min before the flip, it should report −9 deg per min after the flip. This difference can be used to calculate the drift angle and to use the drift angle in compensation of the signal provided in the original or inverted state to provide an accurate signal compensated for drift.

The time period between stable readings will be known and any changes in turning rate during that time can be calculated based on relative changes before and after the flip. For most systems this would be insignificant and could be ignored. The system will then take the difference between the two rates to be caused by the drift error and can then be used to correct the output.

The physical flipping of the gyro sensor can be automatic by mechanical means or manually done by the user as needed.

This solution is particularly useful in response to a need brought to light during experiments regarding a portable MEMS based electronic rate of turn generator.

It is believed that there are no other gyro unit available that can determine the drift error without reference to another source. With the following plan it will be possible. Sensor manufacturers can make use of this technique at the internal chip level within the unit itself. This can be used to provide a way to improve the accuracy of the rate output and enable extended periods of dead reckoning (as a relative heading source).

The concept is to obtain a stable reading from the unit, invert the unit (the whole unit or just the sensor) by manual or mechanical actuator, and obtain a second stable reading. The difference between the two readings will be twice the drift error. If sufficiently sensitive, the readings will also include the error induced by the rotation of the earth which can be removed in the software at the unit level or at the navigation system level, as it is a function of latitude.

### BRIEF DESCRIPTION OF THE DRAWINGS

One embodiment of the invention will now be described in conjunction with the accompanying drawings in which:

FIG. 1 is a schematic illustration of a portable rate generator according to the present invention.

FIG. 2 is a schematic illustration of the portable rate generator of FIG. 1 showing the components.

FIGS. 3A and 3B are schematic illustrations of a rate generator according to the present invention in which the gyroscopic rate sensor is inverted.

In the drawings like characters of reference indicate corresponding parts in the different figures.

### DETAILED DESCRIPTION

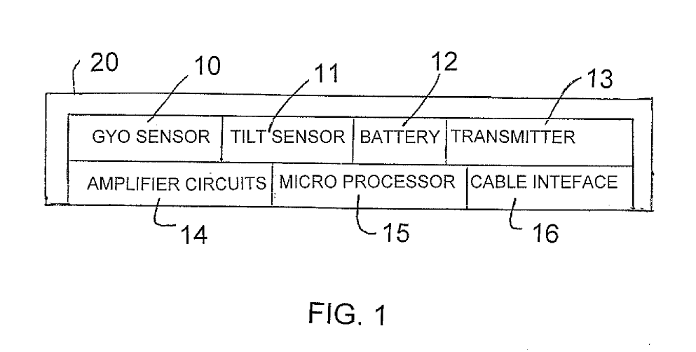

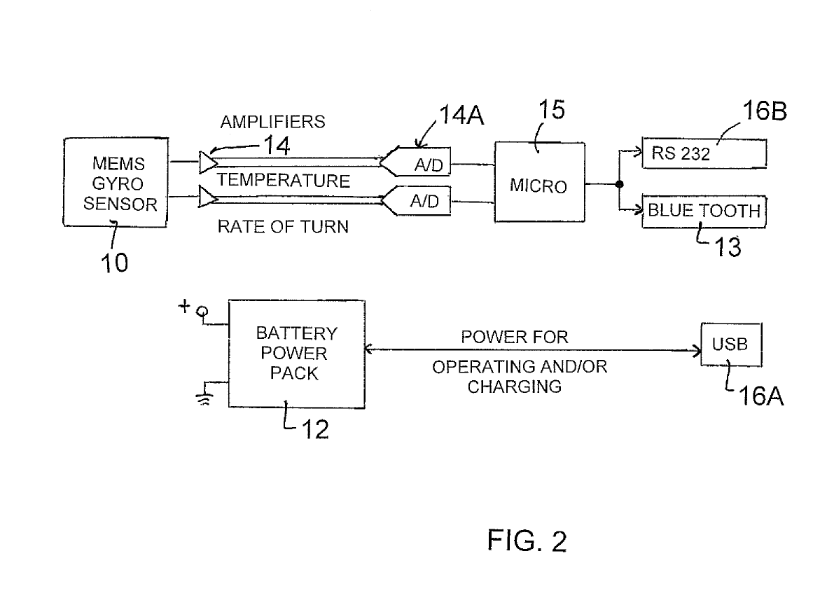

The apparatus for generating a rate of turn shown in FIGS. 1 and 2 includes a gyroscopic device 10 arranged to generate an output indicative of a rate of turn in a desire plane relative to a nominal predetermined direction. The device 10 which generates the output signal as a voltage proportional to rate of turn is mounted in a housing 20 with amplifier circuits 14 including an A/D converter 14A. A microprocessor 15 is programmed to manage the digital signals from the device 10 and to supply them to output terminals 16A or 16B and/or to a Bluetooth transmitter system 13. A battery 12 supplies power and can be recharged from the exterior through the USB port 16A.

The rate of turn signal includes a drift error that is inherent to gyro sensors. To correct this error the system is arranged to generate a first signal with the gyroscopic device in a first orientation and then to generate a second signal with the gyroscopic device inverted relative to the first orientation so that the readings will now be in the opposite direction. The readings taken periodically for example every 5 minutes as a typical value are then compared to determine the drift error and the microprocessor or the host system then uses the drift error to correct the output. The operation can be carried out quickly so that only a small amount of rate information is lost during the test. The system can reconstruct any missing data based on the data collected prior to and after the test.

In FIG. 1 the gyroscopic device is located in a portable unit and the whole unit is inverted either automatically or by manual means to initiate an automatic drift correction. The portable rate generator transmits the rate of turn information, along with other data used to correct for temperature, pitch and roll.

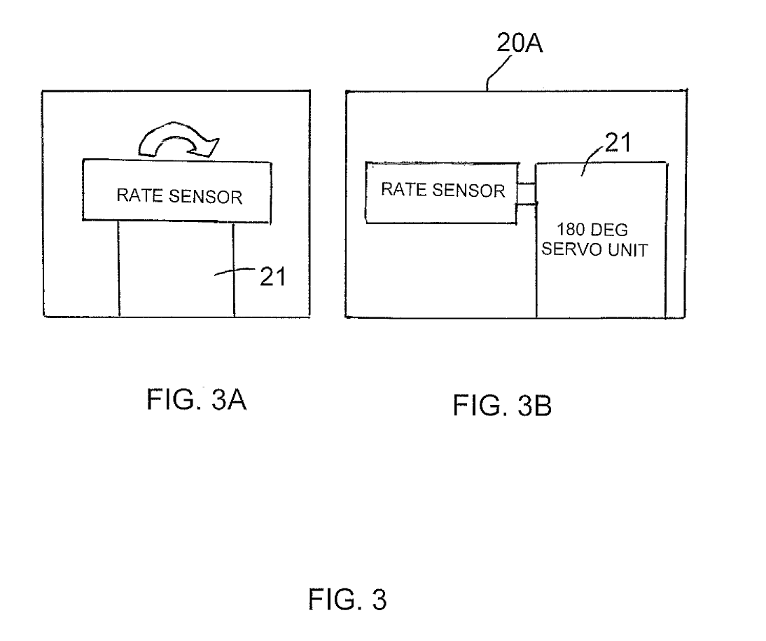

In FIG. 3 the device forms part of a larger system where the gyroscopic device is inverted relative to a housing 20A within which the device is located using a motor 21 within the housing. Thus the software commands the rate sensor unit to flip to an inverted position as shown so that the drift error can be calculated as described.

The output from the rate of turn generator is supplied to a software system which uses the output in a typical navigation software commercially available by others.

In this system, for example, a heading is derived from the rate gyro by integrating the output over time. This would be necessary in the situation where the conventional navigation signals provided by the ship system were unavailable for a period of time due to some system failure.

The operator console of the system runs on the same PC as the Navigation software. The manual settings available are zero, drift correction, rate scale, and temperature scale. The output is converted to NMEA standard.

The gyro is placed on any convenient horizontal surface. The system provides a resolution of 0.1 degrees/minute with a plus or minus 60 degree/minute span and a fresh update each second. The navigation software needs a rate of turn for course computations both in running mode and docking mode. In docking mode the software is able to plot velocity and direction vectors for the bow and the stern of the ship. In all modes the software is able to plot future positions and path of the ship. This predicted information is plotted ahead of the ship to a distance as selected by the user. The navigation software is able to use the rate of turn data to calculate a synthetic ships heading in the event that ships heading is unavailable. The length of time that this remains accurate will be greatly extended by the implementation of my drift correction invention.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for generating a rate of turn comprising:
a gyroscopic device arranged to generate an output indicative of a rate of turn in a desire plane relative to a nominal predetermined direction, the rate of turn signal including a drift error generated by a drift of the actual predetermined direction;
and an arrangement for removing the drift error;
the arrangement being arranged:
to generate a first signal with the gyroscopic device in a first orientation;
to generate a second signal with the gyroscopic device in a second orientation inverted relative to the first orientation so that the readings will now be in the opposite direction;
to compare the two signals to determine the drift error;
and using the drift error to correct the output.

2. The apparatus according to claim 1 wherein the arrangement obtains the drift error without reference to another device.

3. The apparatus according to claim 1 wherein the arrangement obtains the drift error without manual intervention.

4. The apparatus according to claim 1 wherein the gyroscopic device is located in a portable unit and the whole unit is inverted.

5. The apparatus according to claim 1 wherein the gyroscopic device is located in a portable unit and the whole unit is inverted manually.

6. The apparatus according to claim 1 wherein the gyroscopic device is inverted relative to a housing within which the device is located.

7. The apparatus according to claim 1 wherein the gyroscopic device is inverted by a motor within the housing.

8. The apparatus according to claim 1 wherein the arrangement acts to take the difference between the two readings to determine the error.

9. The apparatus according to claim 1 wherein a heading is derived from the rate gyro by integrating the output over time.
